(19) United States
(12) Patent Application Publication
(10) Pub. No.: US 2016/0192459 A1
(43) Pub. Date: Jun. 30, 2016

(54) HOUSEHOLD APPLIANCE THAT DYNAMICALLY CONTROLS SPECTRAL ILLUMINATION TO ENHANCE WAY-FINDING AND DARK-ADAPTATION

(71) Applicant: The Regents of the University of California, Oakland, CA (US)

(72) Inventors: Michael Siminovitch, Woodland, CA (US); Konstantinos Papamichael, El Macero, CA (US); Keith Graeber, Davis, CA (US)

(73) Assignee: The Regents of the University of California, Oakland, CA (US)

(21) Appl. No.: 15/065,664

(22) Filed: Mar. 9, 2016

Related U.S. Application Data
(63) Continuation-in-part of application No. PCT/US2014/054790, filed on Sep. 9, 2014.
(60) Provisional application No. 61/879,937, filed on Sep. 19, 2013.

(51) Int. Cl. H05B 37/02; F24C 15/20; F25D 27/00

(52) U.S. Cl. CPC H05B 37/0218; H05B 37/0227; F25D 27/005; F24C 15/2064

(57) ABSTRACT

The disclosed embodiments relate to a household appliance (such as a refrigerator, stove, microwave, toaster, oven, dishwasher, clothes washer and clothes dryer) that includes exterior and/or interior light sources that can adjust their spectral illumination based on an ambient light level. The household appliance may include a door that an individual may open to access the contents within the household appliance's interior. The household appliance also comprises a light sensor that is configured to detect the ambient light level outside the household appliance. The household appliance further comprises one or more internal light sources that are located within the household appliance's interior. The internal light sources are configured to emit a low-intensity light when the door is open and when the light sensor detects an ambient light level that falls below a threshold value. The one or more internal light sources are also configured to emit a high-intensity light when the door is open and when the light sensor detects an ambient light level that meets or exceeds the threshold value. The external light sources the external light sources can illuminate surfaces in a vicinity of the household appliance.

### CROSS-REFERENCE TO RELATED APPLICATIONS

This application is a continuation-in-part of PCT Application PCT/US2014/054790 filed on 9 Sep. 2014. PCT application PCT/US2014/054790 claims priority under 35 U.S.C. §119(e) to U.S. Provisional Application Ser. No. 61/879,937, filed on Sep. 19, 2013. The contents of the above-listed PCT and provisional applications are hereby incorporated by reference.

### BACKGROUND

### Related Art

The present invention generally relates to smart household appliances that use data from the surrounding environment to adjust their behavior.

While the human eye performs optimally in daylight, the eye is also capable of functioning in low levels of light through dark adaptation. Dark adaptation is a photochemical process where rod cells in the eye's retina begin to accumulate rhodopsin after the eye encounters low levels of light. The eye generally requires 20 minutes of uninterrupted darkness to become fully dark-adapted. Once an individual's eyes are fully dark-adapted, the individual is usually able to see and navigate her surroundings competently in low levels of ambient light.

While dark adaptation might make it easier to navigate a dark environment, dark adaptation still requires 20 minutes of uninterrupted darkness to build up completely, making it a sub-optimal solution for movement in low light. For example, if an individual, who is in a dark environment with fully dark-adapted eyes, were to turn on a bright light, the sudden light may bleach out the built-up rhodopsin in her eyes. As a result, her eyes may quickly lose their dark adaptation as they attempt to readjust themselves to a brighter environment. If the individual subsequently turns off the light, the individual, having lost her previous dark adaptation, may now be less competent at navigating the dark environment. Here, her eyes may require another 20 minutes of darkness to reestablish dark adaptation.

This inconvenient circumstance may present itself in situations where the individual visits a refrigerator in the middle of the night. Here, before opening the refrigerator door, the individual's eyes are fully dark-adapted. Once she opens the door, however, the bright white illumination provided by the refrigerator's interior lights shines into her eyes, destroying their dark adaptation. After the individual closes the refrigerator door, the refrigerator's interior lights turn off and the individual finds herself in a dark environment without dark adaptation. This situation may be inconvenient because the individual may have to turn on a series of house lights in order to navigate back to her bedroom safely. This situation may be dangerous because the individual may attempt to return to her bedroom without turning on any lights at all, raising the chance of injury from stumbles and falls.

### SUMMARY

The disclosed embodiments relate to a household appliance that adjusts spectral illumination based on an ambient light level. The household appliance includes a door that an individual may open to access the contents within the household appliance's interior. The household appliance also comprises a light sensor that is configured to detect the ambient light level outside the household appliance. The household appliance further comprises one or more internal light sources that are located within the household appliance's interior. The internal light sources are configured to emit a low-intensity light when the door is open and when the light sensor detects an ambient light level that falls below a threshold value. The one or more internal light sources are also configured to emit a high-intensity light when the door is open and when the light sensor detects an ambient light level that meets or exceeds the threshold value.

Note that this household appliance can include a refrigerator, a dishwasher, a microwave oven, a gas oven, an electric oven, a toaster, a clothes washer, or a clothes dryer.

In some embodiments, the household appliance further comprises one or more external light sources located at the exterior of the household appliance, wherein one or more of the external light sources is configured to emit a low-intensity light when the light sensor detects an ambient light level that falls below a threshold.

In some embodiments, the one or more of the external light sources illuminate a floor area in a vicinity of the household appliance. The external light sources can also illuminate nearby walls, a kitchen bench or a stovetop.

In some embodiments, the high-intensity light has a shorter wavelength than the low-intensity light.

In some embodiments, the high-intensity light is brighter than the low-intensity light.

In some embodiments, the low-intensity light has a wavelength that is longer than 600 nanometers. For example, the low-intensity light can be amber-colored.

In some embodiments, the low-intensity light has a wavelength and an intensity that substantially minimize the effect of the low-intensity light on a user who views the low-intensity light. For example, the combination of spectral content and intensity of the low-intensity light can be chosen to minimize effects of the low-intensity light on dark adaptation and circadian rhythm of the user.

### BRIEF DESCRIPTION OF THE FIGURES

FIG. 1 illustrates a circuit diagram in accordance with the disclosed embodiments.

FIG. 2 illustrates a refrigerator with control of spectral illumination in accordance with the disclosed embodiments.

FIG. 3 presents a flow chart illustrating the process of automatically adjusting a refrigerator's spectral illumination based on an ambient light level surrounding the refrigerator.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored on a non-transitory computer-readable storage medium as described above. When a system reads and executes the code and/or data stored on the non-transitory computer-readable storage medium, the system performs the methods and processes embodied as data structures and code and stored within the non-transitory computer-readable storage medium.

Furthermore, the methods and processes described below can be included in hardware modules. For example, the hardware modules can include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules.

Overview

The disclosed embodiments use photocell light sensors and lighting spectra above a certain wavelength to provide adequate illumination of an appliance's interior while allowing an individual, who is searching the appliance's interior in the middle of the night, to preserve her eyes' dark adaptation. Cells in the retina of a human eye comprise rod cells (rods) and cone cells (cones). Rods are photoreceptor cells and are almost entirely responsible for night vision because they are able to function in less intense light than cones. The outer segment of a rod contains rhodopsin, which is a photosensitive chemical. When a molecule of rhodopsin absorbs a photon of light with a certain wavelength, it splits into a retinal molecule and an opsin molecule. When the individual exposes her eyes to bright light, rhodopsin present in her retina's rods break down into retinal molecules and opsin molecules, leaving the rods unable to perceive light. Fortunately, the individual's eyes may still rely on cones to see because the appliance provides enough light for cones to function. If the bright light vanishes, however, both the cones and rods are useless, because (1) cones generally do not function in the darkness, and (2) the rods have no rhodopsin. It takes around 20 minutes for enough retinal and opsin molecules to recombine back into rhodopsin, enabling the rods to perceive light once more.

Note, however, that photons that possess wavelengths over 600 nanometers do not cause rhodopsin in a human retina to break down. Lighting spectra with wavelengths between 600 and 700 nanometers generally consist of yellow, amber, orange and red light. In this specification, we refer to lighting of this color as “low-intensity light.” Lighting spectra with wavelengths between 400 and 600 nanometers generally consist of white, violet, blue, cyan and green light. In this specification, we refer to lighting of this color as “high-intensity light.” By having the appliance's internal light source emit a low-intensity light when the individual opens the door, the internal light source may illuminate the appliance's interior with minimal effect on the individual's dark adaptation or circadian rhythm. In other words, the individual who happens to open the appliance at night will preserve her night vision because the low-intensity light provided by the appliance's internal light source will not significantly break down the rhodopsin in her eyes.

The disclosed embodiments provide various advantages. An individual may use a appliance during nocturnal hours without fear of losing her night vision. For example, suppose the individual wakes up in the middle of the night desiring a drink that is located in the appliance. The individual's eyes are completely dark-adapted because the individual has been present in a low-light environment for several hours. When traveling from her upstairs bedroom down to her kitchen on the first floor, the individual has no trouble navigating the darkness because her dark-adapted eyes allow her to see her surroundings. Upon reaching the appliance, the individual opens the appliance door, activating a low-intensity internal light inside the appliance. The low-intensity internal light illuminates the contents of the appliance while leaving her dark adaptation unaffected. After retrieving her drink from the appliance, the individual closes the appliance door, turning off the low-intensity internal light. The individual finds herself in darkness once more. Fortunately, because the appliance's low-intensity internal light did not affect her dark adaptation, the individual can see her surroundings and navigate her way upstairs to her bedroom without problems. Thus, the disclosed embodiments minimize the risk of the individual injuring herself by stumbling or falling down the stairs.

In some cases, the disclosed embodiments may illuminate the appliance's interior with a high-intensity internal light when dark adaptation is not needed. For example, the appliance's internal light may illuminate the appliance's interior with a high-intensity light during the day and with a low-intensity light at night. In other words, the appliance's internal light may illuminate the appliance's interior with a high-intensity light when the surrounding environment is bright, and with a low-intensity light when the surrounding environment is dark. Providing a high-intensity internal light is advantageous during the daytime, because: (1) the individual has no need for dark adaptation during the day; (2) a low-intensity light may not illuminate the interior of the appliance adequately when the surroundings are comparatively bright; and (3) low-intensity light may decrease color perception, while high-intensity white light will not. By allowing the appliance to switch between low-intensity internal lighting at night and high-intensity internal lighting during the day, the disclosed embodiments provide the individual with the appropriate type of internal appliance lighting at the appropriate time.

In some cases, the disclosed embodiments may provide an external low-intensity light that faintly illuminates the appliance's location in the room. Even with full dark adaptation, an individual may still have a hard time navigating to the location of the appliance in a dark room. By providing an external low-intensity light around the appliance, the disclosed embodiments enable the individual to navigate her way toward the appliance more easily in low light conditions without affecting her dark adaptation.

The disclosed embodiments relate to an appliance (e.g., a refrigerator) that adjusts spectral illumination based on an ambient light level. First, the appliance includes a door that an individual may open to access the contents within the appliance's interior. The appliance may comprise one or more doors that lead to the same compartment or different sections, such as a freezer section and a refrigerated section. The appliance also comprises a light sensor that is configured to detect the ambient light level outside the appliance. Note that the light sensor may comprise one or more photocells or photo resistors. Also, note that the light sensor may or may not be physically attached to the appliance and may wirelessly communicate with the appliance via a wireless protocol such as Bluetooth™, ZigBee™, and Z-Wave™. The appliance further comprises one or more internal light sources that are located within the appliance's interior. Both external and internal light sources may be light-emitting diodes (LEDs), fluorescent lights, or incandescent lights. Here, one of the internal light sources is configured to emit a low-intensity light when the door is open and when the light sensor detects an ambient light level that falls below a threshold value. Finally, one of the internal light sources is configured to emit a high-intensity light when the door is open and when the light sensor detects an ambient light level that meets or exceeds the threshold value. The internal light source that emits the low-intensity light may be physically separate from the internal light source that emits the high-intensity light. Here, only one of two light sources may be on or active at any one time. Conversely, a single light source may emit both the low-intensity light and the high-intensity light at different times. The light sensor may cause the single light source to alter its light output depending on the ambient light level outside the appliance. Additionally, if the ambient light level outside the appliance slowly transitions from exceeding the threshold value to falling below the threshold value, the single light source may transition from emitting a high-intensity light to a low-intensity light gradually rather than in a binary manner. Finally, note that the threshold value may correspond to an average amount of illumination provided by sunlight on a clear day, an average amount of illumination available during a moonless night, or some amount of illumination within this range.

In some embodiments, the appliance further comprises one or more external light sources located at the exterior of the appliance, wherein one or more of the external light sources is configured to emit a low-intensity light when the light sensor detects an ambient light level that falls below a threshold. For example, to assist an individual in navigating her way toward the appliance in a darkened room, an external light source in the shape of a strip that extends from the bottom left corner to the bottom right corner of the appliance may emit a low-intensity light. Additionally, the threshold value that the ambient light level crosses to activate the external light source may or may not differ from the threshold value that the ambient light level crosses to cause the internal light sources to emit a low-intensity light instead of a high-intensity light.

In some embodiments, the high-intensity light has a shorter wavelength than the low-intensity light. For example, the wavelength of a high-intensity light may range from 400 to 600 nanometers. As a result, a high-intensity light may be violet, blue, green, or white.

In some embodiments, the high-intensity light is brighter than the low-intensity light. Here, a low-intensity light's lumen output may be less than that of an average two-watt incandescent light bulb, while a high-intensity light's lumen output may be more. In this case, if a single internal light source is responsible for emitting both the low-intensity light and the high-intensity light, the internal light source may change its lumen output when the ambient light level crosses the threshold value.

In some embodiments, the low-intensity light has a wavelength that is longer than 600 nanometers. Note that a low-intensity light may be yellow, amber, orange and red. In this case, if an internal light source is responsible for emitting both the low-intensity light and the high-intensity light, the internal light source may change the color of its illumination when the signal from the control photo-sensor crosses a threshold value.

Circuit Diagram

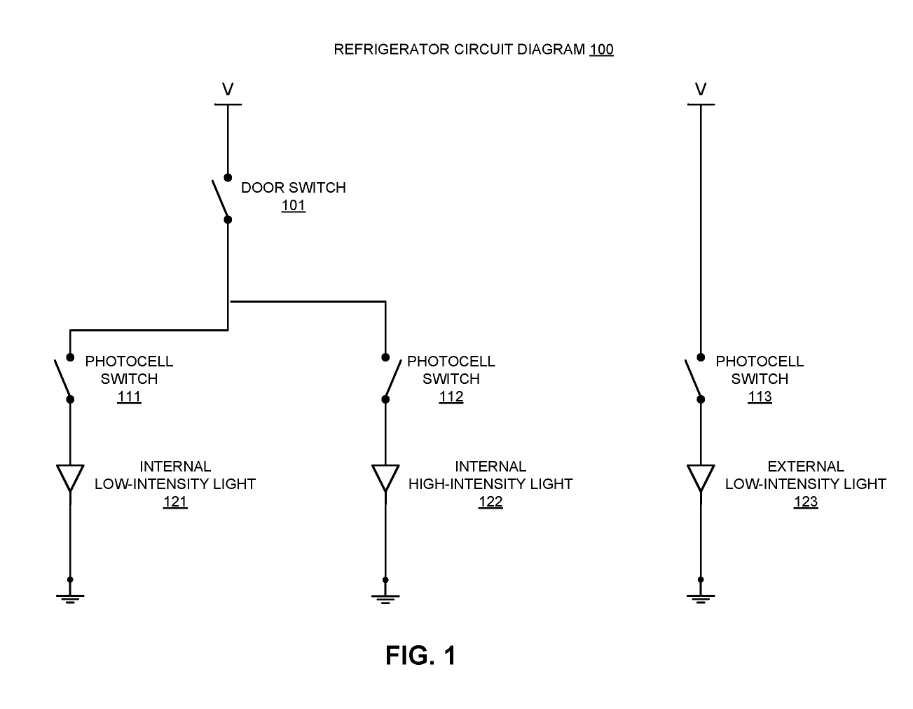

FIG. 1 illustrates the circuit diagram 100 of a refrigerator that adjusts spectral illumination based on an ambient light level in accordance with the disclosed embodiments. As illustrated in FIG. 1, the refrigerator may comprise internal low-intensity light 121 and internal high-intensity light 122, photocell switch 111, photocell switch 112 and door switch 101.

Note that when an ambient light level equals or exceeds a threshold value, photocell switch 111 opens while photocell switch 112 closes. When the ambient light level falls below the threshold value, photocell switch 111 closes while photocell switch 112 opens. When the refrigerator's door is open, door switch 101 closes. When the refrigerator's door is closed, door switch 101 opens. Internal low-intensity light 121 may be turned on by closing door switch 101 and photocell switch 111. Internal high-intensity light 122 may be turned on by closing door switch 101 and photocell switch 112.

As illustrated in FIG. 1, the refrigerator may further comprise photocell switch 113 and external low-intensity light 123. Note that when the ambient light level falls below the threshold value, photocell switch 113 is closed. When the ambient light level equals or exceeds the threshold value, photocell switch 113 is open. External low-intensity light 123 may be turned on by closing photocell switch 113.

Note that different embodiments may use different circuit configurations, and are not limited to the circuit configuration illustrated in circuit diagram 100.

Refrigerator Structure

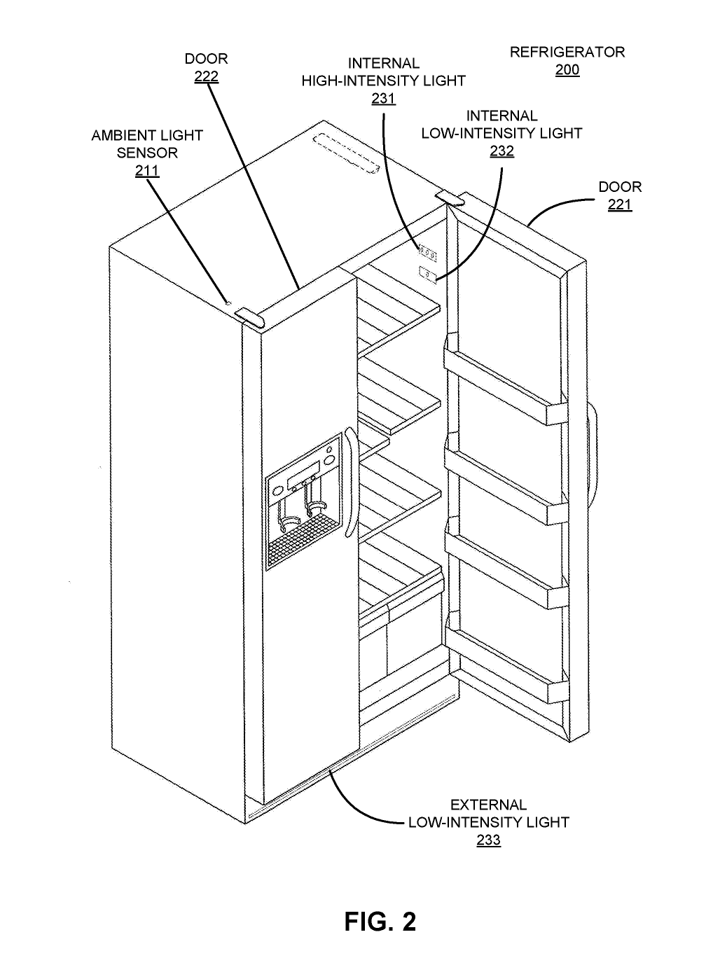

FIG. 2 illustrates the structure of an exemplary refrigerator 200, which is configured to adjust spectral illumination based on an ambient light level in accordance with the disclosed embodiments. As illustrated in FIG. 2, refrigerator 200 includes door 221 and door 222, both of which are configured to close door switch 101 when opened.

Refrigerator 200 further comprises ambient light sensor 211. When an ambient light level falls below a threshold value, ambient light sensor 211 is configured to open photocell switch 112 and close photocell switches 111 and 113. When an ambient level equals or exceeds the threshold value, ambient light sensor 211 is further configured to close photocell switch 112 and open photocell switches 111 and 113.

Refrigerator 200 further comprises internal high-intensity light 231, internal low-intensity light 232, and external low-intensity light 233. Internal high-intensity light 231 turns on when ambient light sensor 211 detects that the ambient light level equals or exceeds the threshold value and an individual opens either door 221 or door 222. Internal low-intensity light 232 turns on when ambient light sensor 211 detects that the ambient light level falls below the threshold value and the individual opens either door 221 or door 222. Finally, external low-intensity light 233, which is located to illuminate a floor area in the vicinity of refrigerator 200, turns on when the ambient light sensor 211 detects that the ambient light level falls below the threshold value.

Adjusting Refrigerator's Illumination Based on Ambient Light Level

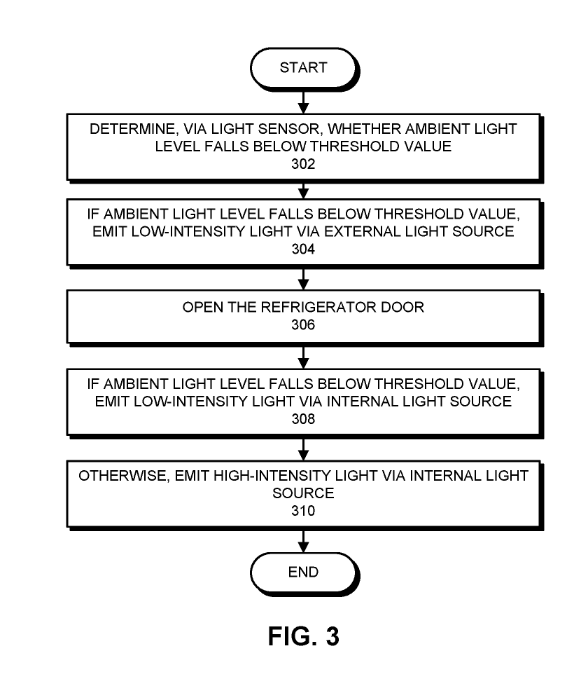

FIG. 3 presents a flow chart illustrating the process of automatically adjusting a refrigerator's spectral illumination based on an ambient light level surrounding the refrigerator.

Initially, during the day when the area around refrigerator 200 is relatively bright, ambient light sensor 211 detects that the ambient light level equals or exceeds a threshold value. In making this determination, ambient light sensor 211 ensures that external low-intensity light 233 is off. At this time, when an individual opens refrigerator door 221 to retrieve a drink from the interior of refrigerator 200, ambient light sensor 211 ensures that only internal high-intensity light 231 turns on (operation 310). Here, internal high-intensity light 231 provides the individual illumination appropriate for the room's daytime light level. Internal high-intensity light 231 turns off when the individual closes door 221.

As time passes, day eventually changes to night, and the ambient light level of the room falls. Here, ambient light sensor 211 determines that the room's ambient light level has fallen below a threshold value, which may be the average illumination provided by the sun at dusk (operation 302).

Because the room's ambient light level falls below the threshold value, ambient light sensor 211 causes external low-intensity light 233 to turn on (operation 304).

Suppose that the individual, having gone to bed upstairs a few hours before, suddenly awakens and desires a drink from the refrigerator. Because the individual has spent more than 20 minutes in a dark room, her eyes are currently dark-adapted. Thus, she has no problem navigating her way downstairs to the refrigerator without turning on any lights. After she reaches the room where the refrigerator is located, the amber illumination provided by external low-intensity light 233 further helps her navigation to the refrigerator 200.

When the individual reaches refrigerator 200, she opens door 221 (operation 306) to retrieve the drink.

Because ambient light sensor 211 has determined that the ambient light level has fallen below the threshold value, and because door 221 has been opened, only internal low-intensity light 232 turns on. Here, internal low-intensity light 232 provides amber illumination to assist the individual in her search for the drink (operation 308). Because the amber illumination possesses a wavelength over 600 nanometers, the amber illumination does not stimulate the rods of the individual's retinas, allowing the individual to retain her dark adaptation. Thus, after retrieving her drink, the individual can easily navigate her way back to the bedroom without turning on any lights.

The foregoing descriptions of embodiments of the present invention have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A household appliance that includes one or more light sources that can adjust spectral illumination based on an ambient light level, comprising:
the household appliance including a door;
a light sensor configured to detect the ambient light level outside the household appliance; and
one or more internal light sources located within an interior of the household appliance;
wherein the one or more internal light sources are configured to emit a low-intensity light when the door is open and when the light sensor detects an ambient light level that falls below a threshold value; and
wherein the one or more the internal light sources are configured to emit a high-intensity light when the door is open and when the light sensor detects an ambient light level that meets or exceeds the threshold value.

2. The household appliance of claim 1, wherein the household appliance is one of:
a refrigerator;
a dishwasher;
a microwave oven;
a gas oven;
an electric oven;
a toaster
a clothes washer; and
a clothes dryer.

3. The household appliance of claim 1, further comprising one or more external light sources located at the exterior of the household appliance wherein one or more of the external light sources is configured to emit a low-intensity light when the light sensor detects an ambient light level that falls below a threshold.

4. The household appliance of claim 3, wherein one or more external light sources located at the exterior of the household appliance.

5. The household appliance of claim 3, wherein the one or more external light sources illuminate surfaces in a vicinity of the household appliance.

6. The household appliance of claim 1, wherein the high-intensity light is brighter than the low-intensity light.

7. The household appliance of claim 1, wherein the low-intensity light has a wavelength longer than 600 nanometers.

8. The household appliance of claim 7, wherein the low-intensity light is amber-colored.

9. The household appliance of claim 7, wherein the low-intensity light has a wavelength and an intensity that substantially minimize the effect of the low-intensity light on a user who views the low-intensity light.

10. A method for adjusting a household appliance's spectral illumination based on an ambient light level, the method comprising:
determining, via a light sensor, whether the ambient light level outside the household appliance falls below a threshold value;
if the household appliance's door is open and the ambient light level falls below the threshold value, emitting a low-intensity light via an internal light source inside the household application; and
if the household appliance's door is open and the ambient light level does not fall below the threshold value, emitting a high-intensity light via the internal light source.

11. The method of claim 10, wherein the household appliance is one of:
a refrigerator;
a dishwasher;
a microwave oven;
a gas oven;
a toaster;
an electric oven;
a clothes washer; and
a clothes dryer.

12. The method of claim 10, further comprising:
if the ambient light level falls below the threshold value, emitting the low-intensity light via an external light source.

13. The method of claim 12, wherein one or more external light sources located at the exterior of the household appliance.

14. The method of claim 12, wherein the one or more external light sources illuminate surfaces in a vicinity of the household appliance.

15. The method of claim 10, wherein the high-intensity light is brighter than the low-intensity light.

16. The method of claim 10, wherein the low-intensity light has a wavelength longer than 600 nanometers.

17. The method of claim 16, wherein the low-intensity light is amber-colored.

18. The method of claim 10, wherein the low-intensity light has a wavelength and an intensity that substantially minimize the effect of the low-intensity light on a user who views the low-intensity light.

19. A fume hood that adjusts spectral illumination based on an ambient light level, comprising:
the fume hood;
a light sensor configured to detect the ambient light level around the fume hood; and
one or more light sources located on or around the fume hood;
wherein the one or more light sources are configured to emit a low-intensity light when the light sensor detects an ambient light level that falls below a threshold value; and
wherein the one or more light sources are configured to emit a high-intensity light when the light sensor detects an ambient light level that meets or exceeds the threshold value.

20. The fume hood of claim 19, wherein the high-intensity light is brighter than the low-intensity light.
